(19) United States
(12) Patent Application Publication
(10) Pub. No.: US 2015/0041173 A1
(43) Pub. Date: Feb. 12, 2015

(54) CABLE MANAGEMENT DEVICE

(71) Applicant: Peter Chin, Fontana, CA (US)

(72) Inventor: Peter Chin, Fontana, CA (US)

(21) Appl. No.: 14/455,602

(22) Filed: Aug. 8, 2014

Related U.S. Application Data
(60) Provisional application No. 61/864,137, filed on Aug. 9, 2013.
(60) Provisional application No. 61/974,398, filed on Apr. 2, 2014.

(51) Int. Cl. H01B 17/58

(52) U.S. Cl. CPC H01B 17/58
USPC 174/69

(57) ABSTRACT

A cable or cord management device comprises a sheath or enclosure that surrounds the cable or cord that facilitates organization and handling of the cable or cord. The management device can include a stiffener, such as a wire, to permit easier installation of cable or cords in the device and adjustment of the length of the cable or cords. The sheath can have an elongate opening closed by a zipper extending along one side of the sheath and another shorter elongate opening extending along the opposite side of the zipper.

### PRIOR APPLICATIONS

This application claims the benefit of U.S. Provisional Application No. 61/864,137 filed Aug. 9, 2013 entitled Cable Management Device and U.S. Provisional Application No. 61/974,398 filed Apr. 2, 2014 entitled Cable Management Device which are hereby incorporated by reference in their entireties.

### TECHNICAL FIELD

The present technology relates to electrical cables and, in particular, cable management devices.

### DESCRIPTION OF THE RELATED TECHNOLOGY

Electronic devices often utilize electronic cables to transmit various electrical currents and signals from one electronic device to another electronic device. Cables can include, for example, audio cables, which may include for example headphones, as illustrated in FIG. 1, video cables, power cables, etc. Cables can be used in conjunction with multimedia devices, mp3 players, cellular telephones, laptop computers, home entertainments systems, and the like.

### SUMMARY

The systems, methods and devices described herein have innovative aspects, no single one of which is indispensable or solely responsible for their desirable attributes. Without limiting the scope of the claims, some of the advantageous features will now be summarized.

One aspect of the present invention is the realization that cables utilized in conjunction with electronic devices, particularly portably electronic devices, can often become tangled or damaged. In addition, due to their finite length, cables can be too long for the intended application. Thus, there exists a need for a cable management device as described herein.

One non-limiting embodiment of the present invention includes a cable management device comprising an elongate sheath configured to receive an electrical cable; wherein the sheath comprises a flexible material configured to prevent the electrical cable from becoming tangled; a wire coupled to the sheath, the wire disposed along a substantial portion of the length of the sheath; wherein the wire is configured to resist bending of the cable management device; and wherein the wire is configured to maintain the shape of the cable management device.

According to another embodiment, the wire is disposed within the sheath.

According to another embodiment, the wire comprises a diameter between approximately 0.01 inch and 0.06 inch.

According to another embodiment, the wire comprises a metal material.

According to another embodiment, the wire comprises stainless steel.

According to another embodiment, the sheath comprises a tube like structure.

According to another embodiment, the sheath is configured to receive the cable via sliding the cable through a first end of the sheath and along the length of the sheath until a portion of the cable exits a second end of the sheath, wherein the second end is opposite the first end.

According to another embodiment, at least one of the ends of the sheath and the opposite end of the sheath is configured to be at least partially sealed once the cable has been installed in the sheath such that the cable is limited from sliding out of the sheath.

According to another embodiment, the sheath comprises an open side along the elongate length of the sheath, wherein the open side is configured to be sealed once the cable has been installed in to the sheath.

According to another embodiment, the open side of the sheath is temporarily sealable such that the cable can later be removed.

According to another embodiment, a method of managing a cable device comprises: installing a cable within a cable management device; wherein installing a cable within a cable management device comprises sliding the cable through an elongate tube-like flexible structure; wherein the cable management device comprises a form retaining element configured to maintain the shape of the cable management device; connecting the cable to an electrical device; manipulating the cable management device to a preferred length; wherein manipulating the cable management device to a preferred length comprises bending the cable management device and effectively bringing each end of the cable closer together.

According to another embodiment, a cable management device comprising: a sheath having a first and a second end that is sized to receive at least one cable and that has an opening at the first and the second end such that end pieces of the cable extend out beyond the first and the second end; and a bendable stiffening element that is positioned within the sheath to permit the sheath to retain a desired shape.

In another embodiment, the sheath comprises a cylindrical sheath that has an opening at a first and a second end such that end pieces of the cable extend out beyond the first and the second end.

In another embodiment, the sheath defines side walls and wherein openings are formed in the side walls to permit an end of the at least one cable to extend outward form the sheath via the openings in the side walls.

In another embodiment, the openings in the side walls are spaced along the length of the sheath.

In another embodiment, the device further comprising at least one retaining member that are positioned adjacent an inner wall of the sheath adjacent at least one of the openings in the sidewall, wherein the retaining members retain the cord in a first configuration by securing a portion of the cord between the retaining member and the inner wall of the sheath.

In another embodiment, the inner wall of the sheath defines a cylindrical shape and the at least one retaining member comprises a plurality of ring shaped retaining members that are arranged to as to extend about the inner circumference of the cylindrical inner wall of the sheath.

In another embodiment, the sheath has a first cross-sectional area along its length and wherein at least one of the openings at the first or second end has a second cross-sectional area greater than the first cross-sectional area.

In another embodiment, a slit is formed that extends from the first end partially along the length of the sheath so as to define a portion of the sheath with the second cross-sectional area.

In another embodiment a closing device is formed on the slit so as to permit the portion of the sheath adjacent the slit to have either the first or second cross-sectional area.

In another embodiment, the closing device comprises a zipper.

In another embodiment, a closing device extends substantially along the length of the sheath so as to permit the sheath to be opened to receive cords.

In another embodiment, the zipper extends from the first end to the second end of the sheath.

In another embodiment, the bendable stiffening member comprises a wire having a rigidity selected so that when the device is bent into a first configuration, the wire substantially maintains the device in the first configuration.

In another embodiment, the device further comprising an unreinforced sheath that is attached to the first end of the sheath, wherein the unreinforced sheath comprises a flexible sheath that is movable along the length of a cord.

In another embodiment, the unreinforced sheath is formed of a softer material than the material forming the sheath.

In another embodiment, the sheath defines an inner surface that is comprised of a plurality of tabs that extend along the length of the sheath so as to define channels that receive the at least one cord.

In another embodiment, the reinforcing member is positioned within one of the tabs so as to be spaced away from the sheath.

In another embodiment, the inner surface is formed by three parallel pieces of fabric that are sewn together to define two tabs.

In another embodiment, at least one of the openings at the first or second end of the sheath has a cover.

In another embodiment, at least one of the first or second ends is flared.

In another embodiment, the device further comprising at least one retaining member that are positioned adjacent an inner wall of the sheath wherein the retaining members retain the cord in a first configuration by securing a portion of the cord between the retaining member and the inner wall of the sheath.

In another embodiment, the inner wall of the sheath defines a cylindrical shape and the at least one retaining member comprises a plurality of ring shaped retaining members that are arranged to as to extend about the inner circumference of the cylindrical inner wall of the sheath.

According to another embodiment a method of organizing cords, the method comprising: positioning at least one cord within a sheath having a stiffening member so that the ends of the cords having at least one end piece extend out of the sheath; bending the cord within the sheath so that a loop is formed inside of the sheath to reduce the amount of excess cord outside of the sheath; and bending the sheath into a desired orientation and length.

In another embodiment, the method further comprising securing the at least one cord within the sheath.

In another embodiment, securing the at least one cord within the sheath comprises securing the bent portion within the sheath.

In another embodiment, securing the at least one cord within the sheath comprises positioning a portion of the at least one cord between a retainer and an inner wall of the sheath.

In another embodiment, the end piece extends out of an opening in the side wall of the sheath.

In another embodiment, the end piece extends out of an opening in the end of the sheath.

In another embodiment, inserting at least one cord in the sheath comprises inserting an end piece through a flared opening at one end of the sheath.

In another embodiment, further comprising opening the sheath with a zipper so as to expose the interior of the sheath and pulling the cord and end piece through

### BRIEF DESCRIPTION OF THE DRAWINGS

The above-mentioned aspects, as well as other features, aspects, and advantages of the present technology will now be described in connection with various embodiments, with reference to the accompanying drawings. The illustrated embodiments, however, are merely examples and are not intended to be limiting. Like reference numbers and designations in the various drawings indicate like elements.

FIG. 1 illustrates a cable.

FIG. 2 illustrates one embodiment a cable management device coupled to a cable.

FIG. 3A illustrates one embodiment of a cable management device in an open position.

FIG. 3B illustrates the cable management device of FIG. 3A in a sealed position.

FIG. 4 illustrates one embodiment of a cable management device which has been manipulated into a bent configuration.

FIG. 5 illustrates one embodiment of a cable management device wrapped around a wrist.

FIGS. 6A-6C are partial perspective views and a cross-sectional view of another embodiment of a cable management device.

FIG. 6D and 6E are partial perspective views of additional optional features of the cable management device shown in FIGS. 6A-6C.

FIG. 7A and 7B are perspective views of another embodiment of a cable management device.

FIGS. 8A-8F are perspective views of another embodiment of a cable management device.

FIGS. 9A and 9B are perspective views of another embodiment of a cable management device.

### DETAILED DESCRIPTION

In the following detailed description, reference is made to the accompanying drawings, which form a part of the present disclosure. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and form part of this disclosure. For example, a system or device may be implemented or a method may be practiced using any number of the aspects set forth herein. In addition, such a system or device may be implemented or such a method may be practiced using other structure, functionality, or structure and functionality in addition to or other than one or more of the aspects set forth herein. Alterations and further modifications of the inventive features illustrated herein, and additional applications of the principles of the inventions as illustrated herein, which would occur to one skilled in the relevant art and having possession of this disclosure, are to be considered within the scope of the invention.

Descriptions of unnecessary parts or elements may be omitted for clarity and conciseness, and like reference numerals refer to like elements throughout. In the drawings, the size and thickness of layers and regions may be exaggerated for clarity and convenience.

Features of the present disclosure will become more fully apparent from the following description and appended claims, taken in conjunction with the accompanying drawings. It will be understood these drawings depict only certain embodiments in accordance with the disclosure and, therefore, are not to be considered limiting of its scope; the disclosure will be described with additional specificity and detail through use of the accompanying drawings. An apparatus, system or method according to some of the described embodiments can have several aspects, no single one of which necessarily is solely responsible for the desirable attributes of the apparatus, system or method. After considering this discussion, and particularly after reading the section entitled “Detailed Description” one will understand how illustrated features serve to explain certain principles of the present disclosure.

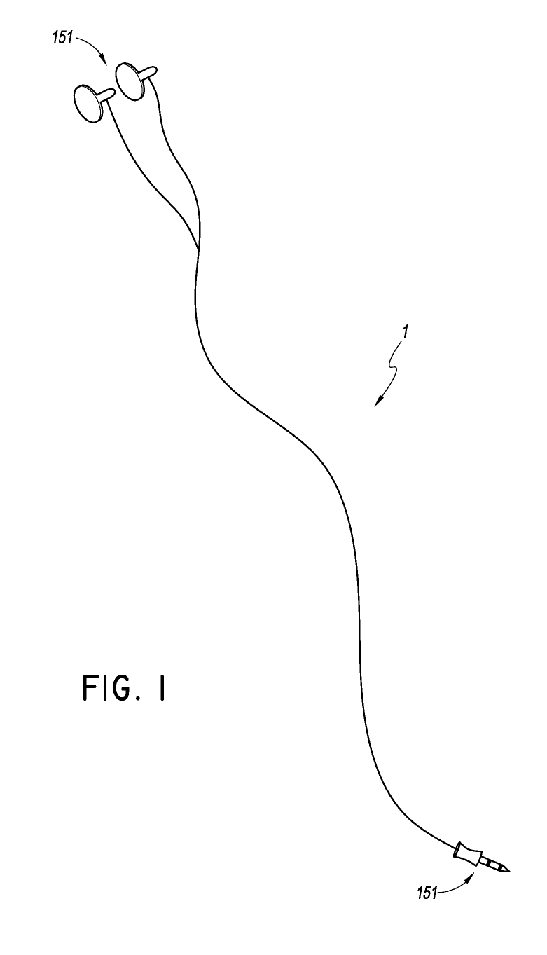

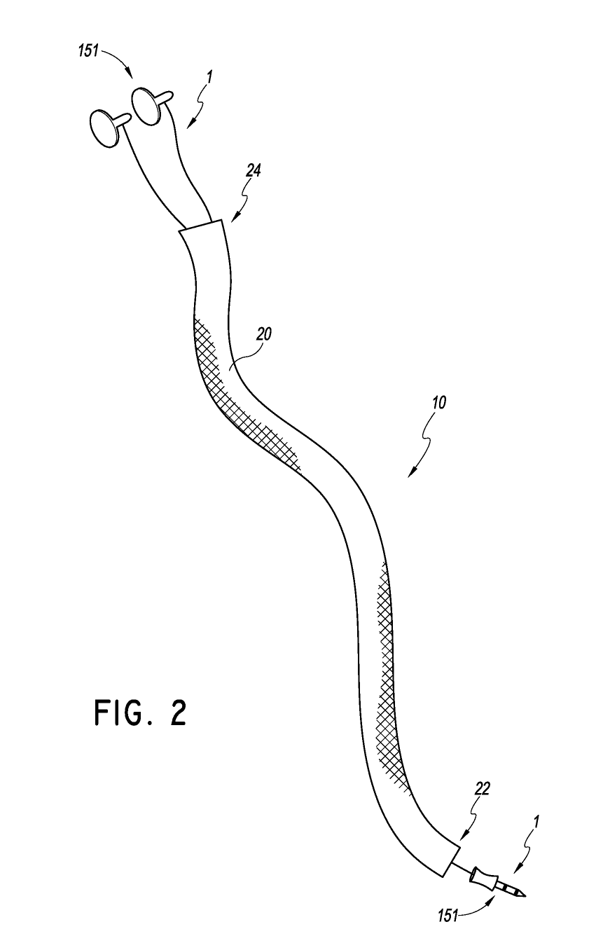

Embodiments described herein generally relate to systems, devices, and methods related to electronic cables. More specifically, some embodiments relate to cable management devices. FIG. 1 illustrates a cable 1, and more specifically a headphone cable. A headphone cable is one type of cable 1 which can be coupled with the cable management device 10. Other types of cables can also be used without departing from the spirit and scope of the present invention. FIG. 2 illustrates one embodiment of a cable management device 10 coupled to a cable 1. In some embodiments, the cable management device 10 can be configured to couple to a cable 1. The cable management device 10 can surround at least a portion of the cable 1. In some embodiments, the cable management device 10 can provide a layer of protection around the cable 1. In some embodiments, the cable management device 10 can be configured to shield the cable 1 from interference. In some embodiments, the cable management device 10 can prevent tangling of the cable 1. The cable management device 10 can include a sheath 20. In some embodiments, the sheath 20 can form an elongate enclosure surrounding at least a portion of a cable 1. The sheath 20 can form an elongate tube-like structure. In some embodiments, the cable 1 can be fed through the sheath 20 such that at least a portion of the cable 1 is installed within the sheath 20. In some embodiments, the sheath 20 is configured to receive the cable 1 via sliding the cable 1 into a first end 22 of the sheath 20 and along the length of the sheath 20 until a portion of the cable 1 exits a second end 24 of the sheath 20. The second end 24 can be opposite the first end 22. In some embodiments, at least one end of the sheath 20 can be at least partially sealed once the cable 1 has been installed to limit the cable 1 from sliding out of the sheath 20.

In some embodiments, the sheath 20 can include apertures configured to provide access to intermediate portions of a cable 1 which may contain features such as buttons or controls. In other embodiments, the sheath 20 may not form a tube-like structure and the cable 1 can be coupled to a portion of the sheath 20 such that the cable 1 is not surrounded by the sheath 20. The sheath 20 can comprise a material which is configured to bend and flex as the cable 1 bends and flexes. The sheath 20 can be manufactured from a variety of materials which may include, for example, polypropylene, nylon, polyester, woven fabric, unwoven fabric, paper, etc. As is also shown in FIG. 1, the cable 1 includes end pieces 151 that can comprise plugs, ear phones, speakers etc. It will also be appreciated that the end pieces 151 can have a cross-section that is wider than the cross-section of the sheath 20 which can complicate installation of the cord 1 within the sheath 20. This issue will be discussed in greater detail below.

FIG. 3A illustrates one embodiment of a sheath 20 in an open position. FIG. 3B illustrates the sheath 20 of FIG. 3A in a sealed position. In some embodiments, the sheath 20 can be open along a side 26, as illustrated in FIG. 3A. The sheath 20 can be configured to be closed once the cable 1 has been installed in the sheath 20, as illustrated in FIG. 3B. In some embodiments, a sealed seam 28 can be disposed along the side of the sheath 20. In some embodiments, the sheath 20 can be configured to be permanently sealed. Permanently sealing the sheath 20 may include, for example, stitching, adhesives, heat pressing, etc. In some embodiments, the sheath 20 can be configured to be temporarily sealed. Temporarily sealing the sheath 20 may include, for example, hook and loop fastening, zippers, adhesive, buttons, snaps, etc. In some embodiments, the sheath 20 can comprise a material configured to stick to itself, such that the sheath 20 can be wrapped around the cable 1 and at least a portion of itself, thus sealing itself and retaining the cable 1 inside the sheath 20. In some embodiments, the cable management device 10 can be configured to fit a variety of cables 1. In some embodiments, the cable management device 10 can be configured to include a plurality of cables 1. In some embodiments, the cable management device 10 can be configured to temporarily receive a cable 1. In other embodiments, the cable management device 10 can be configured to permanently receive a cable 1. In other embodiments, the cable management device 10 can include a cable 1.

In some embodiments, the cable management device 10 can include a form retaining element or stiffening member, such as a wire 30 as illustrated in FIGS. 3A and 3B. In some embodiments, the wire 30 can be disposed within the sheath 20. In other embodiments, the wire 30 can be disposed within a pocket formed in the cable management device 10. In other embodiments, the wire 30 can be located on the exterior of the cable management device 10. In some embodiments, the wire 30 can be disposed along the length of the elongate cable management device 10. In some embodiments, the wire 30 can be disposed along a substantial portion of the length of the cable management device 10. In some embodiments, the wire 30 can be affixed to the sheath 20. The wire 30 can resist bending of the cable management device 10. In some embodiments, the wire 30 is configured to resist bending of the cable management device 10. In some embodiments, the wire 30 wire 30 is configured to maintain the shape of the cable management device 10. In some embodiments, the wire 30 can comprise a metal material such that when the wire 30 is bent, it tends to remain in the bent configuration. In some embodiments, the wire 30 can comprise stainless steel. Stainless steel is a corrosion resistant material. Also, stainless steel is a strong yet flexible and resilient material which can withstand repeated bending of the cable management device 10 without failing. The form retention qualities of the wire 30 can allow a user to manipulate the cable management device 10, along with the cable 1, in nearly any desirable configuration.

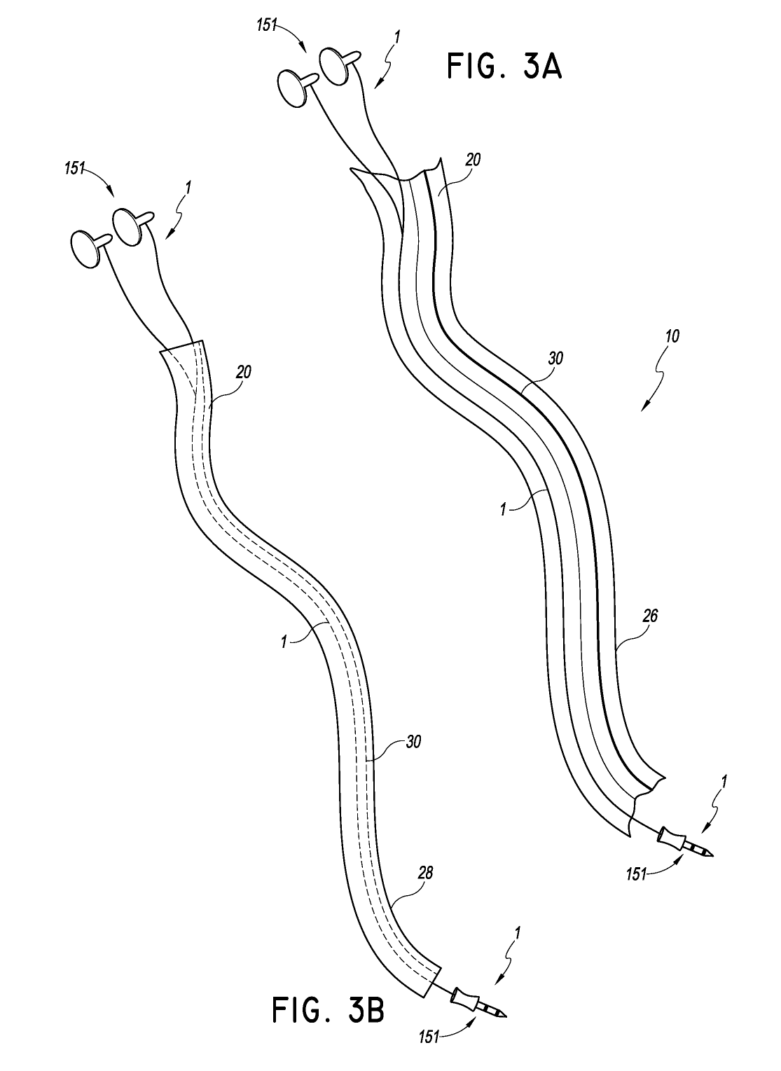

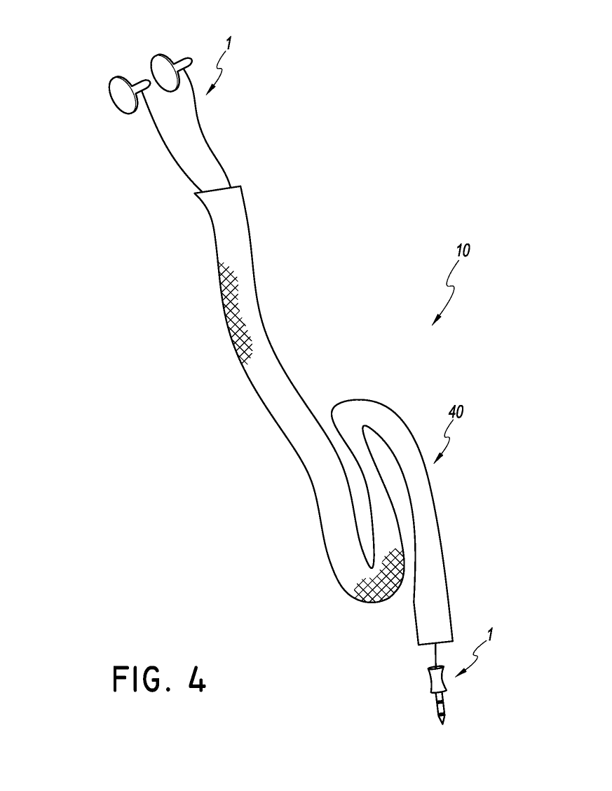

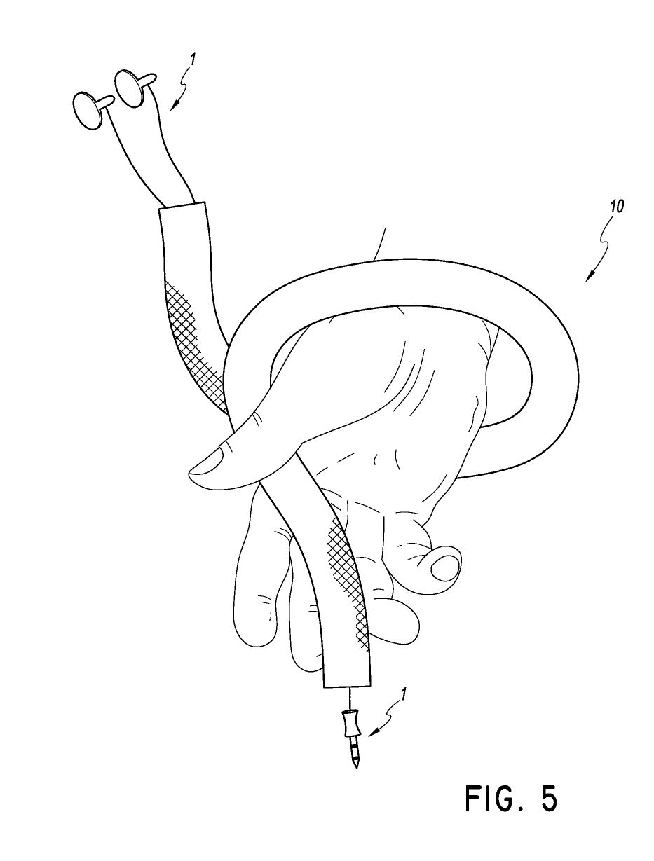

FIG. 4 illustrates one embodiment of a cable management device 10 which has been manipulated into a bent configuration. The wire 30 allows the cable management device 10 to be wrapped or bent to include a bend 40 such that the effective length of the cable management device 10, and the cable 1, is shortened to a desirable length, as illustrated in FIG. 4. FIG. 5 illustrates one embodiment of a cable management device 10 wrapped around a wrist 50. In some embodiments, the cable management device 10 can be wrapped around various animate or inanimate objects, which may include for example, a wrist of 50 a person utilizing the cable 1.

In some embodiments, the cable management device 10 can be configured to couple to a particular type of cable 1. The stiffness and form retaining qualities of a wire 30 can depend on the diameter of the wire 30. In some embodiments, a cable management device 10 configured for a smaller diameter or more flexible cable 1 can include a wire 30 of a smaller diameter. In some embodiments, a cable management device 10 configured for a larger diameter or less flexible wire 30 can include a wire 30 of a larger diameter. In some embodiments, the wire 30 can comprise stainless steel hanging wire 30. In some embodiments, a cable management device 10 can include a wire 30 between approximately 0.01 inch and 0.060 inch in diameter. In some embodiments, a cable management device 10 can include a wire 30 between approximately 0.02 inch and 0.05 inch in diameter. In some embodiments, a cable management device 10 can include a wire 30 between approximately 0.03 inch and 0.04 inch in diameter. In some embodiments, a cable management device 10 configured to couple to a thinner cable 1, such as a headphone cable, can include a wire 30 between approximately 0.02 inch and 0.035 inch in diameter. In some embodiments, a cable management device 10 configured to couple to a medium size cable 1, such as a charging cable for a cellular telephone, can include a wire 30 between approximately 0.03 inch and 0.04 inch in diameter. In some embodiments, a cable management device 10 configured to couple to a larger size cable 1, such as for a laptop computer, can include a wire 30 between approximately 0.035 inch and 0.055 inch in diameter. In other embodiments, other thickness wires 30 can be included in the cable management device 10 depending on the thickness and flexibility of the intended cable 1.

In other embodiments, the cable management device 10 can be configured to retain its configuration without the aid of a wire 30. In some embodiments, the form retaining element can be included in the sheath 20. In some embodiments, the sheath 20 can be configured to retain its configuration. In some embodiments, the sheath 20 can comprise a material which tends to remain in its present configuration. In other embodiments, the sheath 20 can be configured to temporarily couple to another portion of the sheath 20, such that when the sheath 20 is bent or wrapped into a configuration wherein the sheath 20 touches another portion of the sheath 20, the portions are temporarily coupled together, retaining the configuration of the cable management device 10. In some embodiments, the sheath 20 material can be configured to stick to itself. In other embodiments, the sheath 20 can include hook and loop closures such that the sheath 20 can stick to another portion of the sheath 20. In some embodiments, the sheath 20 can include an adhesive that only sticks to another portion of the sheath 20 material. In some embodiments, the sheath 20 can include an adhesive that only sticks to another portion of the sheath 20 which also incorporates the adhesive.

In some embodiments, the sheath 20 can comprise one or more colors. In some embodiments, lettering, images, and/or logos can be included on the sheath 20. In some embodiments, various methods, which may include for example, screen printing, sublimation, embroidery, etc., can be utilized to add lettering, images, and/or logos to the sheath 20.

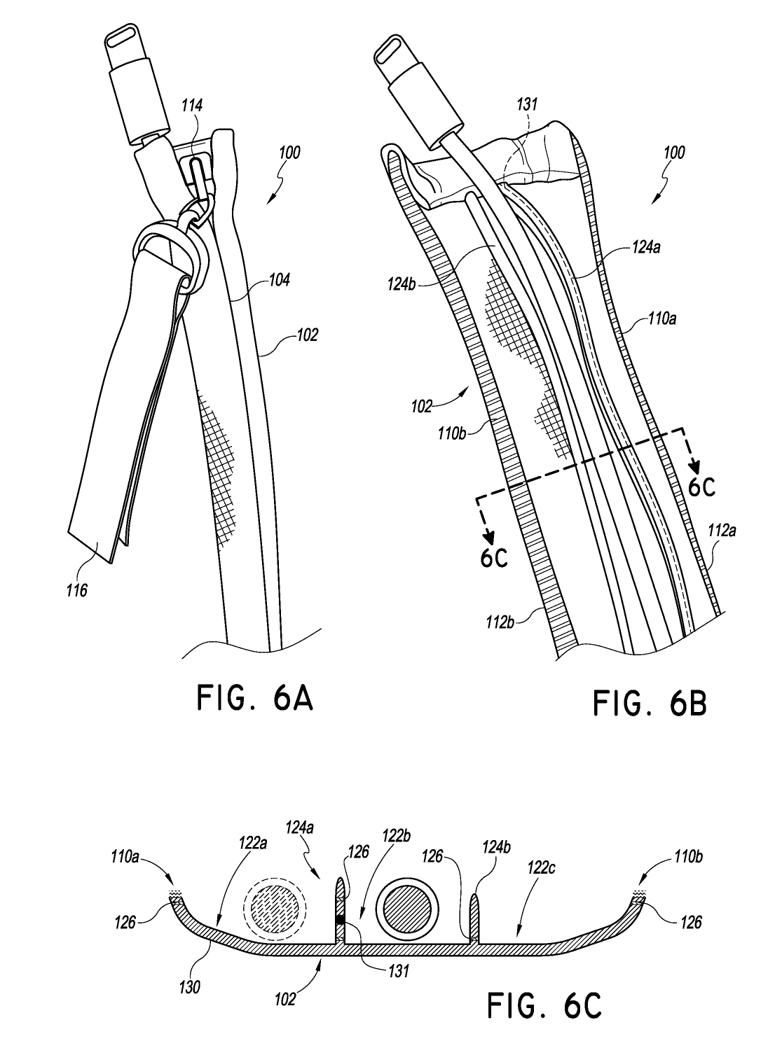

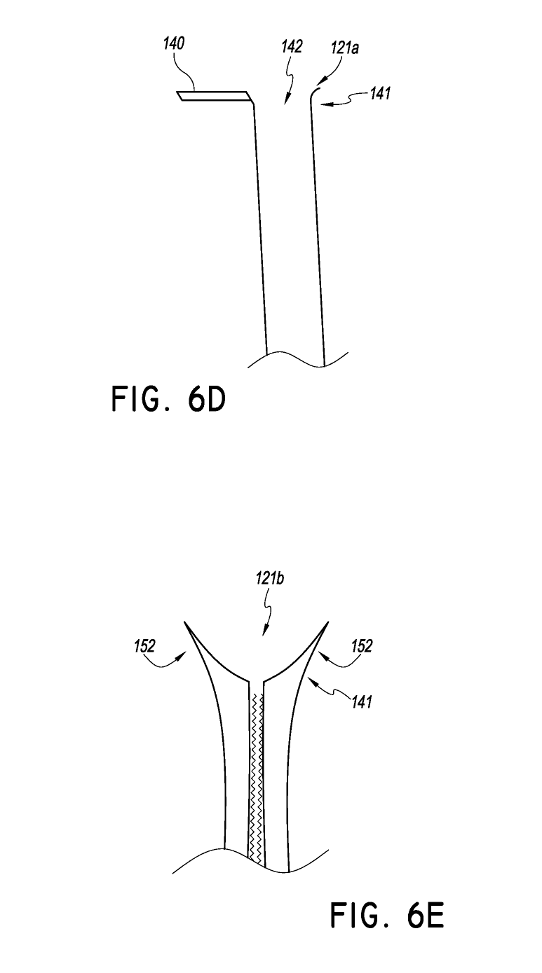

FIGS. 6A-6E illustrate another embodiment of a cable management device 100 of the instant application. As shown, the device 100 includes a sheath 102 that is preferably closed along the length of the device via a sealing mechanism 104 such as a zipper. The zipper 104 may include a handle 106 to facilitate the ease of opening the sheath 102. The zipper 104 may expend from one end of the sheath 102 to the other in the same manner as described above or may extend only partially the length of the sheath 102. The zipper 104 includes first and second tracks 110a 110b that are formed on the outer edges 112a, 112b of the fabric members comprising the sheath 102. The zipper 104 may further include a zipper member 114 that may have an optional tab 116 for securing the tracks 110a, 110b to each other.

As is shown in FIGS. 6B and 6C when the zipper 104 is unzipped, the sheath 102 can preferably lie in a generally planar configuration. This facilitates positioning of the cables 101 into the sheath 102. As described below, one or more cables 101 can be positioned within the sheath 102. In this embodiment, the interior portion 120 of the sheath 102 may be comprised of a plurality of pieces of fabric material 122 that are sewn together. In one implementation, the interior portion 120 is formed of a first, second and third pieces of fabric 122a, 122b and 122c that are sewn together so as to define two raised tabs 124a, 124b that extend outward from the interior portion 120 of the sheath. As is shown in FIG. 6B, the tabs 124a, 124b preferably extend the length of the sheath 102 and facilitate arranging the cables 101 into a more organized manner as will be described in greater detail below. In one specific, non-limiting implementation, the pieces of fabric 122 can be formed of a material such as a polyester blend material although persons of ordinary skill in the art can appreciate that various other materials can also be used without departing from the scope of the present invention.

In the interior pieces of fabric 122a, 122b, and 122c are sewn to the zipper tracks 110a, 110b in a well-known manner so as to define a seam 126. The seam 126 further connects the interior portion 120 of the sheath to an exterior portion 130 of the sheath 102.

As is also shown in FIG. 6C, the raised tabs 124a, 124b have seams 126 that extend across the raised seams 124a, 124b which induce the raised seams 124a, 124b to extend upwards away from the interior surface 120 of the sheath 102. This induces the raised tabs 124a, 124b to be positioned within the inner volume of the sheath 102 which provides guide tracks that guide cables 101 to extend along the length of the sheath 120. In one implementation, the interior surface 120 of the sheath is approximately 3.5 cm wide and the raised tabs 124a, 124b extend upwards approximately 0.5 cm. that the width it will be appreciated however of the sheath 102 and the length of the tabs 124a, 124b can vary depending on the number and size of the cords that are positioned within the sheath 102.

As is also shown in FIG. 6C, a stiffening member or wire 131, such as the members described above, can be positioned within the seam 124a. Preferably, the stiffening member 131 is positioned within the seam 124a for ease of manufacture and also because it spaces the stiffening member 131 from the interior surface 120 of the sheath 102. This results in the stiffening member 131 not being immediately adjacent the interior and exterior surfaces 120, 131 of the sheath 102 which results in less wear of the surfaces as a result of the stiffening member 130 rubbing against the surfaces during bending of the device 100. A further seam 126 is formed above the stiffening member 131 to secure the stiffening member 130 in the desired orientation away from the interior surface 130.

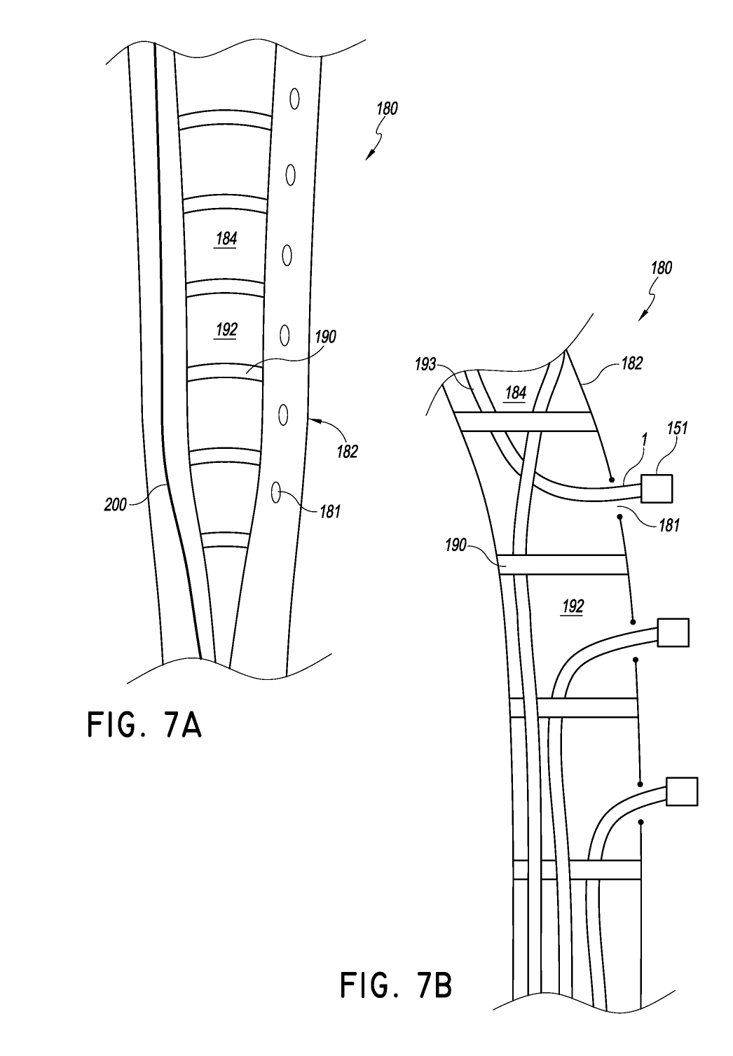

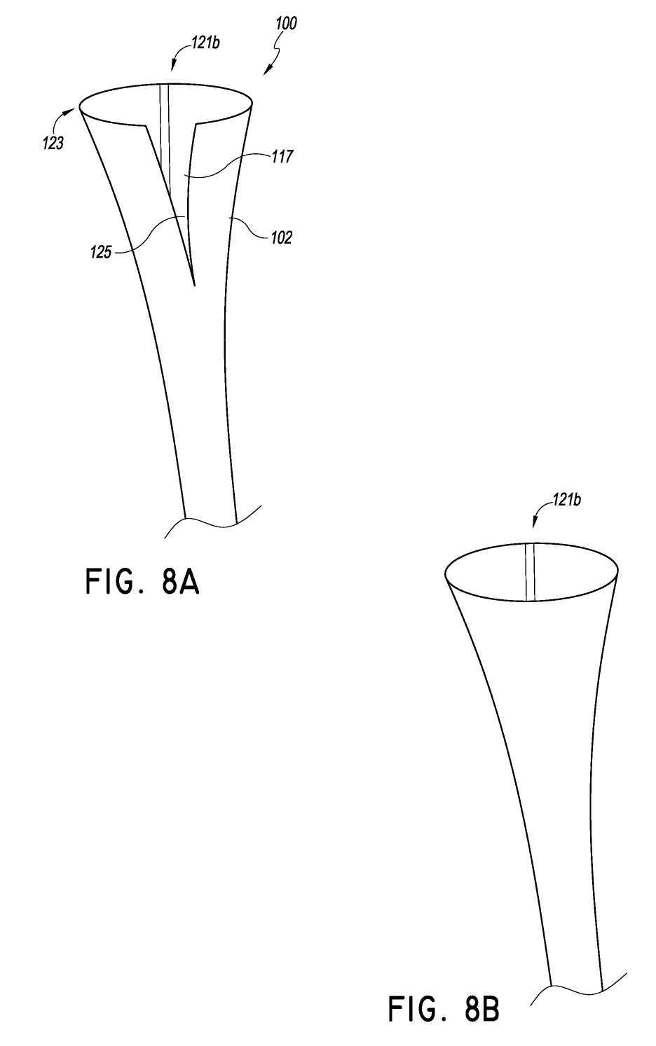

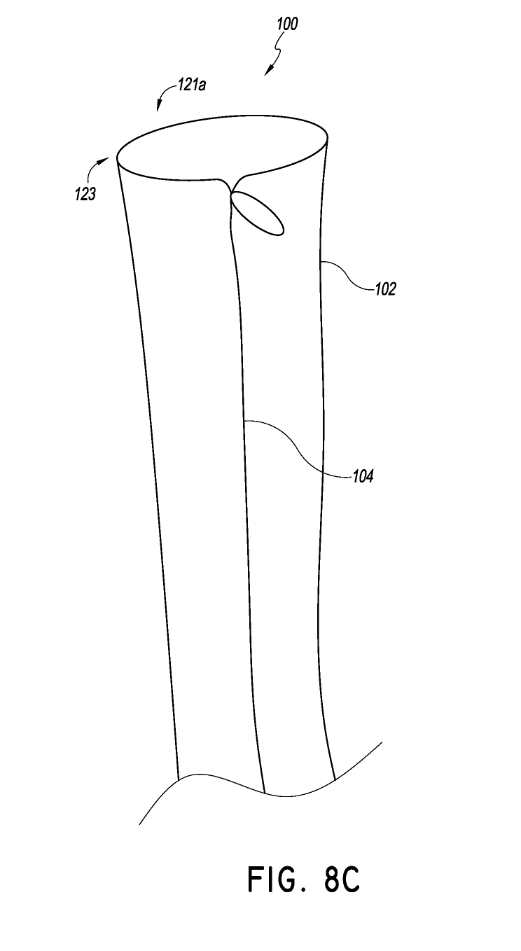

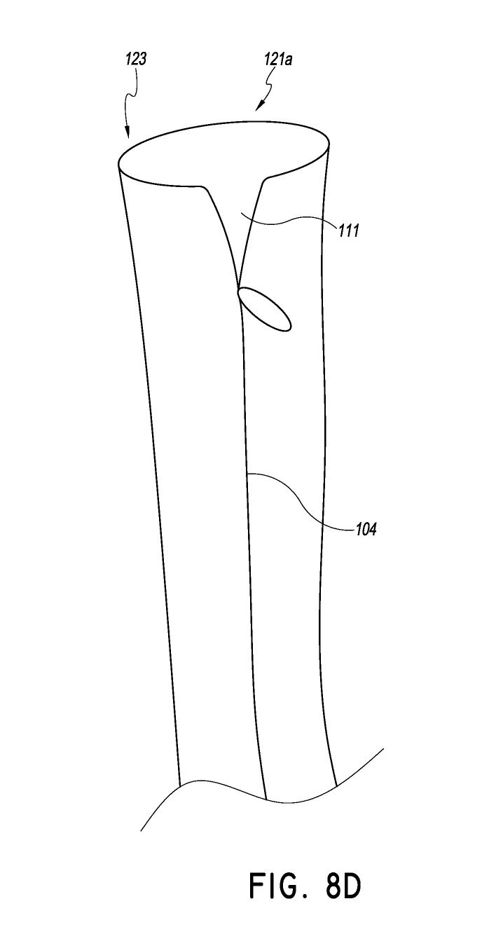

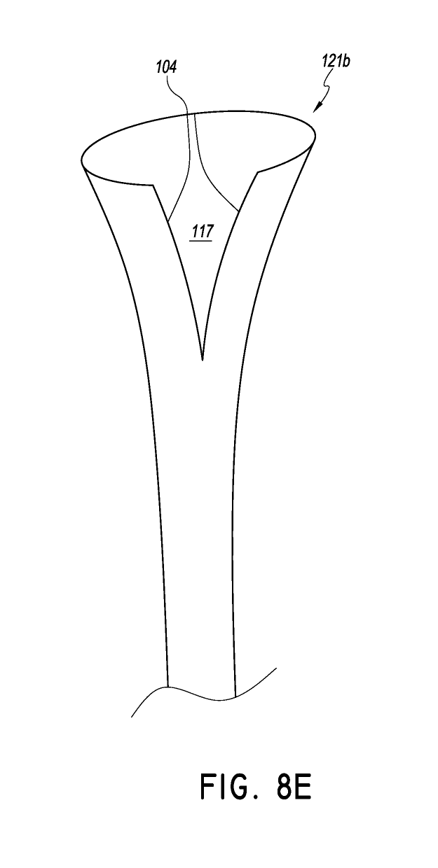

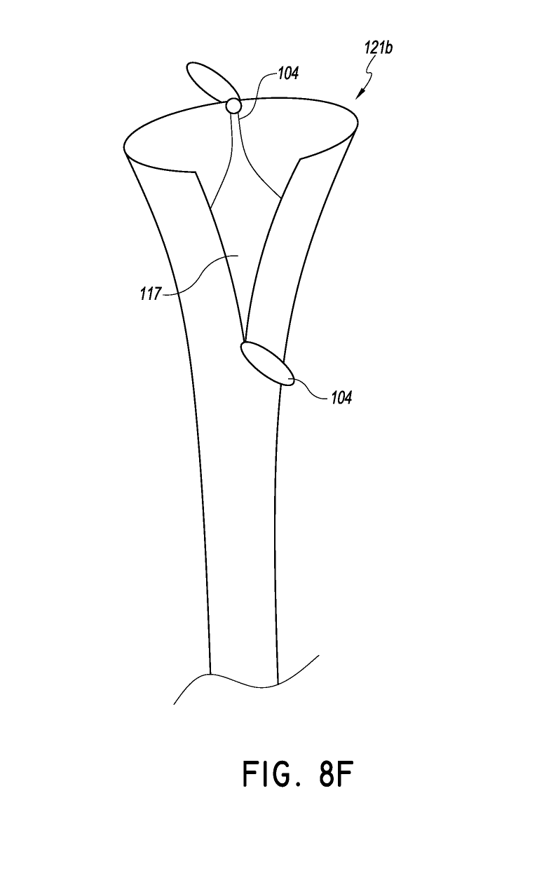

The ends 106 of the sheath 102 may vary depending upon the implementation. As shown in FIG. 6D, one end 121a, may have a flap 140 that covers the end opening 142, and is preferably sealable using a releasable fastener such as hook and loop fastener, zippers buttons or the like. A cord 1 such as the cord illustrated in FIG. 1 will have an end piece 151 (FIGS. 1 and 7B) which can comprise a plug or ear plugs or some type of larger diameter device. This portion of the cord 1 extends out of the opening 142 in the end 121a. However, to inhibit the end piece 151 from falling back into the interior volume of the sheath, the flap 140 may extend over the end 121a. Further, the end 121a may also be flared outward 141 to facilitate removal of the end piece 151 and also permit more flexibility of movement of the end pieces 151 and the cable 1. More specifically, since the end 121a is flared, movement of the end piece 151 outward from an axis defined by the sheath 102 will result in less contact between the cord and the edges 121 of the sheath 102 which results in less potential for damage or wear to the edge of the sheath member 102. These features will be described in greater detail in reference to FIGS. 8A-8F described below.

The other end 121b shown in FIG. 6E may also be flanged or have a slit so as to permit easier installation of the cords. More specifically, as shown in FIG. 6E, the end 121b may also be more broadly flared out 141either through the inclusion of a slit or by having a larger diameter section of the sheath 102 adjacent the end 121b. The end pieces 151 can have varying sizes and inserting the end pieces into the sheath 102 can be complicated in implementations where the zipper 104 does not extend the entire length of the sheath 102. To facilitate installation of the end pieces 151 of the cord 1 into the device 100, the ends may be flared outward 152 or have slits (described in greater detail below in reference to FIGS. 8A-8E) which also provide additional protection to the sheath 120 in the manner described above.

The extent to which the end 121a, or 121b is flared is dependent upon the size of the end pieces of the cord 1. It will be appreciated that some end pieces are relatively small, e.g., jacks for plugging into phones etc. and some might be larger, e.g., plugs for plugging into electrical outlets so the size of the sheath 102 and the openings 121a, 121b will vary depending upon implementation without departing from the spirit or scope of the present invention.

FIGS. 7A and 7B illustrate another embodiment of a cord organization device 180. In this implementation, the device 180 includes a sheath 182 formed of a material such as a blend of polyester. Moreover, the device 180 may be formed to have a larger diameter to accommodate a larger number of cords. It will be appreciated that some devices may be used for one or two cords simply to protect the cord and can be used in individual applications, such as a person using the cord to protect their ear phone cords or to protect their power cord for their cellular phone, pad device or the like. In other implementations, larger numbers of cords, such as the cords connecting various components of a desk top computer and associated accessories such as printers, displays, handsets, scanners, etc. may also be positioned within a cable management device 180 so as to accommodate the cords. Placing large numbers of cords into such a device provides protection to the cords in that the cords are less likely to be dislodged and also provide a more aesthetic appearance.

FIGS. 7A and 7B illustrate an embodiment of a cord organization device 180 that includes side openings 181 that permit the cords 1 to be removed out of the interior volume of a sheath 184 at spaced intervals. To facilitate positioning multiple cords within the sheath 182, a plurality of rigid or semi-rigid rings 190 may be formed on an inner wall 192 of the sheath 182. In one implementation the rings 190 are made of plastic but other suitable materials can also be sued. The 190 rings are preferably positioned so as to be adjacent the side openings 181. As is shown in FIG. 7B, the cords 1 can be positioned underneath the rings 190 so that the rings 190 secure the cord 1 against the inner wall 192 of the device 180.

In this way, the length of cord 1 that extends out of the side openings can be regulated which further allows for cord management. It will be appreciated that similar rings can be used in the same manner to regulate the length of cord that extends out of the end openings such as the end openings 121a, 121b of the embodiments shown in FIGS. 6A-6E and FIGS. 8A-8F described below. In all disclosed embodiments, slack cord can be stored within the cord management device such that the amount of cord that extends outward of the management device can be regulated. In one implementation, as shown in FIG. 7B, the cord can be looped 193 and the loop 193 can then be secured by a retainer or ring 190.

The side openings 181 may be formed along an edge 194 of a slit 196 that is formed to permit installation of the cords into the interior volume 184 of the sheath and the slit 196 may be sealed using a zipper or similar device in the same manner as described above. The side openings 181 may also be formed elsewhere along the sheath 182 and can be sized to accommodate different sizes of cables and cable end pieces 150.

As is also shown in FIG. 7A, a stiffening member 200 may also be included into the sheath 182 that performs the same purpose as described above. More specifically, the stiffening member 200 allows the cable organization device 180 to be bent into a desired orientation or configuration and then maintained in this orientation or configuration. With larger cable assemblies or with more cables, the stiffening member 200 may need to be thicker to resist the tension of the cables to retain the organization device 180 in a desired configuration.

As shown in FIGS. 8A-8F, a cable management device 100 may comprise an elongate sheath 102, a zipper 104, a first end 121a, and a second end 121b. The elongate sheath 102 may be of a generally tubular shape, and may comprise a space 120 inside of the sheath. The elongate sheath 102 may comprise a wire or stiffening member 131 within at least part of the sheath 120. The wire 131 may comprise a generally ductile metal, such as copper, or other similar material, that may be re-shaped multiple times without significant permanent deformation. The elongate sheath 102 may comprise a fabric that may be ribbed, and or radially expandable. The elongate sheath 102 may be between several inches and several feet long, and in some embodiments, may be 2 feet, 3 feet, or 4 feet in length, or another length.

In some embodiments, the cable management device 100 may comprise a zipper 104, or other structure configured to close at least part of the sheath 102. The sheath 102 may comprise an opening 111 axially along at least part of the sheath 102, and the zipper 104 may be configured to at least temporarily close part of the opening 111. The zipper 104 may extend from a first end 121a of the sheath 102 to a second end 121b of the sheath 102. When the zipper 104 is zipped, at least part of the zipper 104 may be hidden from view. For instance, as a non-limiting example, when the zipper 104 is zipped, at least some of the teeth of the zipper 104 may not be visible or fully visible. When the zipper 104 is unzipped, at least part of the inside 120 of the elongate sheath 102 may be exposed. The wire 131 may be disposed in at least part of the inside 120 of the sheath 102. In some embodiments, the zipper 104 may not completely unzip, such that material on one side of the zipper 104 may not become fully detached from material on the other side of the zipper.

As shown in FIGS. 8A and 8B, the elongate sheath may comprise a second end 121b. The second end 121b may be disposed at or near the bottom of the zipper 104. In some embodiments, the second end 121b comprises a flare shape 123, such that the diameter or cross-sectional area of the elongate sheath 102 may generally increase towards the first end. As shown in FIG. 8A, in some embodiments, the second end 121b may comprise a slit 125 that extends longitudinally from the second end 121b of the sheath 120 at least partially towards the first end 121a of the sheath 120. As shown in FIG. 8B, in some embodiments, the sheath 120 may not substantially comprise a slit, such that the bottom edge of the sheath extends substantially circumferentially around the sheath.

With continued reference to FIGS. 8A and 8B, and as shown in FIG. 8E, the second end 121bmay be configured such that when the zipper 104 is unzipped to the second end 121b or close to the first end 122a, the second end 121b defines a void 117 through which a cable may be inserted. In some embodiments, a slit 125 may aid with insertion of a cable. In some embodiments, the flare shape of the second end 121b may aid with insertion of a cable. For instance, as a non-limiting example, when the zipper 104 is unzipped, it may be disposed at or near the second end 121b of the sheath 102. An opening may be formed through the sheath 102, such that a cable may be inserted through the opening in the bottom of the sheath, and through the opening or void 117 created by the unzipped zipper 104.

Since some cables have ends that are larger in diameter or cross-sectional area, it may be advantageous to have a larger opening through which the cable may be disposed. Once the cable has been at least partially inserted through the opening in the end 120b and through the opening 117 created by the zipper, the zipper 104 may be at least partially zipped up. Since, in some embodiments, the process of closing the zipper 104 may dispose the material of the sheath 102 more tightly around the cable, the cable may become more secure within the sheath 102 as the zipper 104 is engaged. In some embodiments, if the sheath 102 was substantially tubular shaped at the first end, and the zipper 104 did not fully unzip, then it may be difficult to insert a cable and/or ends of a cable into and through the cable management device. Although the first end of the sheath may comprise a flare shape, other shapes may perform equally as well, and the scope of the invention is not limited to the shape of the first end of the elongate sheath.

As shown in FIGS. 8C and 8D, the elongate sheath 102 may comprise a first end 121a that is on the opposite end of the sheath 102 as compared to the first end 121a. The first end 121a of the sheath may be at or near the top of the zipper 104. In some embodiments, the second end may comprise a flare shape 123b, or a change in diameter or cross-sectional area of the sheath. In some embodiments, the flare shape 123 at the first end 122b may not be as large or pronounced as a flare shape 123 at the second end 121a of the sheath 102. In some embodiments, the first end 121a may not comprise a slit, such that when the zipper 104 is fully zipped the first end 121a of the sheath is generally circumferentially continuous around the first end 121a of the sheath 102. The first end 121a of the sheath 102 may be configured such that when the zipper 104 is zipped up to the first and or near the first end 121a and minimal space may exist between the cable and inside surface 120 of the sheath. The first end 121a of the sheath 102 may comprise a hem or folded-over piece of fabric.

FIG. 8F illustrates that the flared end 121b of the sheath 102 can have a slit 111 that is also closed by a zipper 104. Consequently, the slit 111 can be used to facilitate the installation of the cable into the sheath 102 and can then be removed to provide more secure retention of the cords. As is also shown in FIG. 8F, the zipper 104 on the slit 111 is in addition to the zipper 104 that extends the entire length or substantially the entire length of the sheath 102.

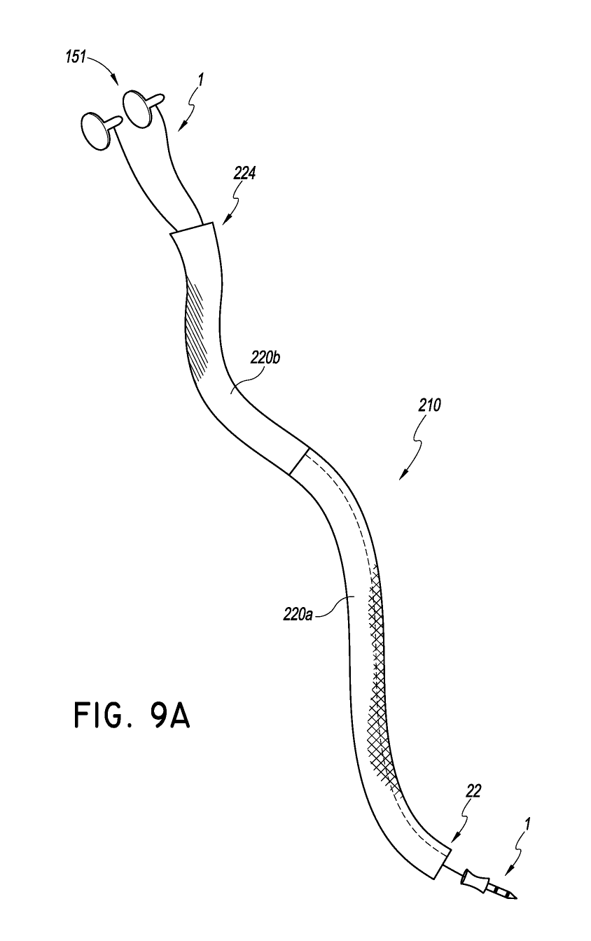

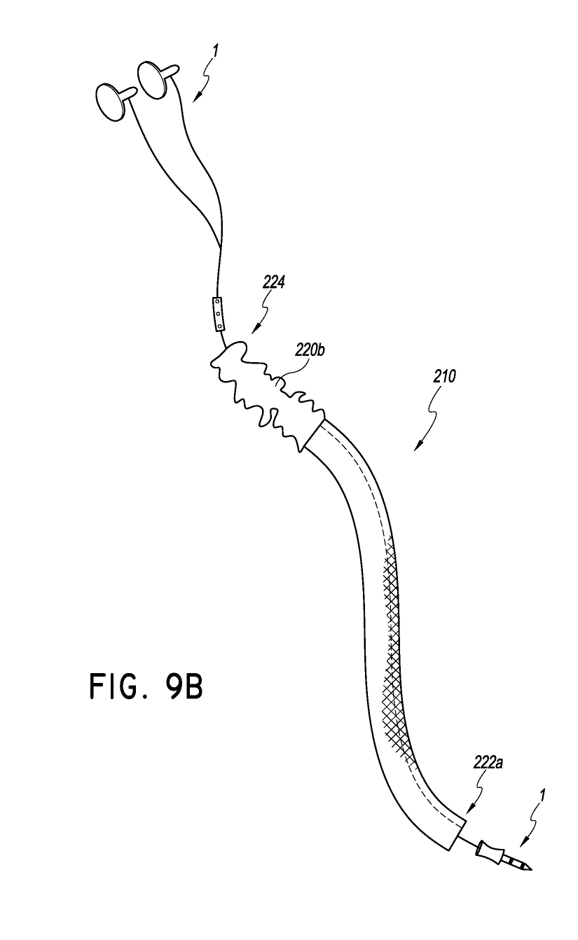

FIGS. 9A and 9B illustrate another embodiment of a cable management device 210. In this embodiment, the cable management device 210 includes a first sheath 220a and a second sheath 220b. The first sheath 220a is formed of a more resilient fabric such as the polyester blend fabric described above. The first sheath also includes the stiffening member or wire 230. The cords 1 are positioned in the first sheath 220a in the same manner as described in the various embodiments above and the first sheath 220a can incorporate any of the previously described features.

As shown in FIGS. 9A and 9B, however, the device 210 also includes a second sheath 220b. More specifically, the second sheath or cover member 220b does not include the stiffening element and is preferably formed of a softer fabric. The second sheath 220b can be used to cover devices such as ear phone cords with a softer fabric. In this way, when a user places ear phones in their ears, the softer fabric of the second sheath 220b may be more pleasant than the more robust fabric of the first sheath 220a.

In one embodiment, the second sheath 220b does not include the stiffening element 230 and is also collapsible in the manner shown in FIG. 9B. This permits the second sheath 220b to be vertically displaced from the end pieces 150. In one implementation, this is advantageous if the end pieces are items such as ear phones that have to be laterally separated from each other and have separate cords. By collapsing the second sheath 220 in the manner shown in FIG. 9B, the separate cords of the ear phone can be more easily separated. In one implementation, the outer end 224 of the second sheath 220 has a resilient member in it, such as an elastic band, that allows the outer end 224 of the second sheath 220 to engage to the cords so as to be maintained in a desired position along the cords 1.

In some embodiments, the cable management device may be configured such that a cable, including an audio or power cable, may be disposable within at least part of the elongate sheath 102, such as in the inside 120 of the sheath 102. The elongate sheath 102 may be configured to protect a cable inside against crimping, wear, abrasion, sharp objects, or various other dangers that may negatively affect a cable. The cable management device may be of a similar length as a cable contained within, or may be of another length. The cable management device may be colored or textured, or have other surface features. The cable management device may comprise a decorative zipper pull, or other decorative or functional features attached to at least part of the sheath or zipper. In some embodiments, the cable management device may be worn as an accessory or garment. In some embodiments, the cable management device may be configured to effectively shorten the length of cable, by twisting, folding, knotting, or otherwise configuring the device such that the first end of the cable is closer to the second end of the cable than were the cable to be fully outstretched. In some embodiments, the cable management device may be configured to support a phone. For instance, as a non-limiting example, the cable management device may be folded into an L-shape, or other shape, such that when the phone or other electronic device is placed on its edge on or near the cable management device the phone may generally remain in an upright position and resist falling or repositioning onto a broadside. In some embodiments, the cable management device may be configured to hang and/or support a phone or other electronic device.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the device as implemented.

Certain features that are described in this specification in the context of separate implementations also can be implemented in combination in a single implementation. Conversely, various features that are described in the context of a single implementation also can be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination. Similarly, while operations are depicted in the drawings in a particular order, this should not be understood as requiring that such operations be performed in the particular order shown or in sequential order, or that all illustrated operations be performed, to achieve desirable results.

In describing the present technology, the following terminology may have been used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in this numerical range are individual values such as 2, 3 and 4 and sub-ranges such as 1-3, 2-4 and 3-5, etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

It should be noted that various changes and modifications to the presently preferred embodiments described herein will be apparent to those skilled in the art. Such changes and modifications may be made without departing from the spirit and scope of the invention and without diminishing its attendant advantages. For instance, various components may be repositioned as desired. It is therefore intended that such changes and modifications be included within the scope of the invention. Moreover, not all of the features, aspects and advantages are necessarily required to practice the present invention. Accordingly, the scope of the present invention is intended to be defined only by the claims that follow.

What is claimed is:

1. A cable management device comprising:
a sheath having a first and a second end that is sized to receive at least one cable and that has an opening at the first and the second end such that end pieces of the cable extend out beyond the first and the second end; and
a bendable stiffening element that is positioned within the sheath to permit the sheath to retain a desired shape.

2. The device of claim 1, wherein the sheath comprises a cylindrical sheath that has an opening at a first and a second end such that end pieces of the cable extend out beyond the first and the second end.

3. The device of claim 2, wherein the sheath defines side walls and wherein openings are formed in the side walls to permit an end of the at least one cable to extend outward form the sheath via the openings in the side walls.

4. The device of claim 3, wherein the openings in the side walls are spaced along the length of the sheath.

5. The device of claim 4, further comprising at least one retaining member that are positioned adjacent an inner wall of the sheath adjacent at least one of the openings in the sidewall, wherein the retaining members retain the cord in a first configuration by securing a portion of the cord between the retaining member and the inner wall of the sheath.

6. The device of claim 5, wherein the inner wall of the sheath defines a cylindrical shape and the at least one retaining member comprises a plurality of ring shaped retaining members that are arranged to as to extend about the inner circumference of the cylindrical inner wall of the sheath.

7. The device of claim 1, wherein the sheath has a first cross-sectional area along its length and wherein at least one of the openings at the first or second end has a second cross-sectional area greater than the first cross-sectional area.

8. The device of claim 7, wherein a slit is formed that extends from the first end partially along the length of the sheath so as to define a portion of the sheath with the second cross-sectional area.

9. The device of claim 8, wherein a closing device is formed on the slit so as to permit the portion of the sheath adjacent the slit to have either the first or second cross-sectional area.

10. The device of claim 9, wherein the closing device comprises a zipper.

11. The device of claim 1, wherein a closing device extends substantially along the length of the sheath so as to permit the sheath to be opened to receive cords.

12. The device of claim 1, wherein the bendable stiffening member comprises a wire having a rigidity selected so that when the device is bent into a first configuration, the wire substantially maintains the device in the first configuration.

13. The device of claim 1, further comprising an unreinforced sheath that is attached to the first end of the sheath, wherein the unreinforced sheath comprises a flexible sheath that is movable along the length of a cord and wherein the unreinforced sheath is formed of a softer material than the material forming the sheath.

14. The device of claim 1, wherein the sheath defines an inner surface that is comprised of a plurality of tabs that extend along the length of the sheath so as to define channels that receive the at least one cord.

15. The device of claim 14, wherein the reinforcing member is positioned within one of the tabs so as to be spaced away from the sheath.

16. The device of claim 15, wherein the inner surface is formed by three parallel pieces of fabric that are sewn together to define two tabs.

17. The device of claim 1, wherein at least one of the openings at the first or second end of the sheath has a cover.

18. The device of claim 1, wherein at least one of the first or second ends is flared.

19. The device of claim 1, further comprising at least one retaining member that are positioned adjacent an inner wall of the sheath wherein the retaining members retain the cord in a first configuration by securing a portion of the cord between the retaining member and the inner wall of the sheath.

20. The device of claim 19, wherein the inner wall of the sheath defines a cylindrical shape and the at least one retaining member comprises a plurality of ring shaped retaining members that are arranged to as to extend about the inner circumference of the cylindrical inner wall of the sheath.

21. A method of organizing cords, the method comprising:
positioning at least one cord within a sheath having a stiffening member so that the ends of the cords having at least one end piece extend out of the sheath;
bending the cord within the sheath so that a loop is formed inside of the sheath to reduce the amount of excess cord outside of the sheath; and
bending the sheath into a desired orientation and length.

22. The method of claim 21, further comprising securing the at least one cord within the sheath.

23. The method of claim 22, wherein securing the at least one cord within the sheath comprises securing the bent portion within the sheath.

24. The method of claim 23, wherein securing the at least one cord within the sheath comprises positioning a portion of the at least one cord between a retainer and an inner wall of the sheath.

25. The method of claim 24, wherein the end piece extends out of an opening in the side wall of the sheath.

26. The method of claim 21, wherein the end piece extends out of an opening in the end of the sheath.

27. The method of claim 21, wherein inserting at least one cord in the sheath comprises inserting an end piece through a flared opening at one end of the sheath.

28. The method of claim 21, further comprising opening the sheath with a zipper so as to expose the interior of the sheath and pulling the cord and end piece through
